(19) United States
(12) Patent Application Publication
(10) Pub. No.: US 2020/0187697 A1
(43) Pub. Date: Jun. 18, 2020

(54) COOKING DEVICE AND COMPONENTS THEREOF

(71) Applicant: SharkNinja Operating LLC, Needham, MA (US)

(72) Inventors: Scott J. Stewart, Boston, MA (US); Thomas Guerin, Boston, MA (US); Christopher T. Martin, Concord, MA (US); Michaela Dubeau, Uxbridge, MA (US)

(21) Appl. No.: 16/711,029

(22) Filed: Dec. 11, 2019

Related U.S. Application Data
(60) Provisional application No. 62/779,237, filed on Dec. 13, 2018.

(51) Int. Cl. A47J 27/00; A47J 27/04; A47J 27/08; A47J 37/06; A47J 36/06; A23L 5/10; H05B 3/00

(52) U.S. Cl. CPC A47J 27/004; A47J 27/04; A47J 27/08; A47J 37/0641; A23V 2002/00; A23L 5/15; H05B 3/0076; A47J 2027/043; A47J 36/06

(57) ABSTRACT

A cooking system for cooking food includes a housing having a hollow interior, a lid movable relative to said housing, and at least one heating element associated with one of said housing and said lid. The cooking system is operable in a plurality of modes including a conduction cooking mode and a thermal radiation cooking mode. In said conduction cooking mode, the cooking system is operable as a conductive cooker and in said thermal radiation cooking mode, the cooking system is operable as a radiative cooker.

### CROSS-REFERENCE TO RELATED APPLICATIONS

This application claims the benefit of U.S. Provisional Application Ser. No. 62/779,237, filed Dec. 13, 2018, which is incorporated herein by reference in its entirety.

### BACKGROUND

Embodiments of the present disclosure relates generally to a cooking device and components thereof, and more specifically, a multifunction device configured to perform the operation of a plurality of distinct cooking devices, the multifunctional cooking device optionally employing various components for cooking in the distinct cooking modes.

Conventional cooking devices, such as pressure cookers and air fryers each perform a single cooking operation, and as such, these devices employ different components and method for cooking food items. As such, multiple devices are required to perform various cooking operations. For consumers that wish to enjoy food cooked in different ways via different operations, an accumulation of these devices can occur. Such an accumulation of cooking devices is often prohibitive from a standpoint of cost and storage space. For at least these reasons, it would be desirable to integrate the functionality of several cooking devices into a single user-friendly cooking device.

### SUMMARY

According to an embodiment, a cooking system for cooking food includes a housing having a hollow interior, a lid movable relative to said housing, and at least one heating element associated with one of said housing and said lid. The cooking system is operable in a plurality of modes including a conduction cooking mode and a thermal radiation cooking mode. In said conduction cooking mode, the cooking system is operable as a conductive cooker and in said thermal radiation cooking mode, the cooking system is operable as a radiative cooker.

In addition to one or more of the features described above, or as an alternative, in further embodiments when in said conduction cooking mode the cooking system is operable as at least one of a pressure cooker, steam cooker, slow cooker, searing surface, and sautéing surface, and when in said thermal radiation cooking mode the cooking system is operable as at least one of an air fryer, baking/roasting oven, broiler, toaster, heater, defroster, and dehydrator.

In addition to one or more of the features described above, or as an alternative, in further embodiments including a food container receivable in the hollow interior, wherein food is receivable in said food container in both said conduction cooking mode and said thermal radiation cooking mode.

In addition to one or more of the features described above, or as an alternative, in further embodiments said food container includes a container surface, and food is receivable in said food container in contact with said container surface in both said conduction cooking mode and said thermal radiation cooking mode.

In addition to one or more of the features described above, or as an alternative, in further embodiments the at least one heating element is a first heating element disposed at or below a lower extent of said container surface, and a second heating element disposed at or above an opening at an upper extent of said food container.

In addition to one or more of the features described above, or as an alternative, in further embodiments said second heating element is disposed in said lid.

In addition to one or more of the features described above, or as an alternative, in further embodiments including a first temperature sensor proximate said first heating element and a second heating sensor in said lid.

In addition to one or more of the features described above, or as an alternative, in further embodiments said at least one heating element includes a radiative heating element that emits heat energy at infrared wavelengths.

In addition to one or more of the features described above, or as an alternative, in further embodiments said at least one heating element includes a radiative heating element that emits heat energy at visible light wavelengths.

In addition to one or more of the features described above, or as an alternative, in further embodiments said at least one heating element includes a radiative heating element that emits heat energy at ultraviolet wavelengths.

In addition to one or more of the features described above, or as an alternative, in further embodiments said at least one heating element includes a radiative heating element that emits microwaves.

In addition to one or more of the features described above, or as an alternative, in further embodiments said at least one heating element includes a radiative heating element that emits radio waves.

In addition to one or more of the features described above, or as an alternative, in further embodiments comprising a reflector positionable within an enclosure defined by said food container and said lid.

In addition to one or more of the features described above, or as an alternative, in further embodiments said reflector is contoured to direct thermal radiation towards a specific region of said enclosure.

In addition to one or more of the features described above, or as an alternative, in further embodiments said container surface of said food container is said reflector.

In addition to one or more of the features described above, or as an alternative, in further embodiments said reflector is connected to said lid.

In addition to one or more of the features described above, or as an alternative, in further embodiments comprising an insert recievable within said food container, wherein said reflector is connected to said insert, or said insert is said reflector.

In addition to one or more of the features described above, or as an alternative, in further embodiments comprising at least one support foot extending from said housing.

In addition to one or more of the features described above, or as an alternative, in further embodiments said at least one foot includes a first foot and a second foot disposed at opposite sides of said housing.

In addition to one or more of the features described above, or as an alternative, in further embodiments said first foot is larger in at least one dimension than said second foot.

In addition to one or more of the features described above, or as an alternative, in further embodiments comprising a second lid movable relative to said housing to selectively seal said hollow interior.

In addition to one or more of the features described above, or as an alternative, in further embodiments said lid is movable between an open position and a closed position, and said second lid is receivable with said lid when said lid is in said open position.

In addition to one or more of the features described above, or as an alternative, in further embodiments said second lid is coupled to said housing when said cooking system is in said conduction cooking mode.

In addition to one or more of the features described above, or as an alternative, in further embodiments said second lid is detachable from said housing.

In addition to one or more of the features described above, or as an alternative, in further embodiments said cooking system is transformable between said conduction cooking mode and said thermal radiation cooking mode without removing the food item from said hollow interior.

In addition to one or more of the features described above, or as an alternative, in further embodiments said lid is attached to said housing via a hinged connection.

In addition to one or more of the features described above, or as an alternative, in further embodiments said lid is attached to said housing via a detachable connection.

In addition to one or more of the features described above, or as an alternative, in further embodiments said lid is attached to said housing via a detachable hinged connection.

According to another embodiment, a method for cooking food in a cooking system includes providing a housing having with a hollow interior, providing a lid movable relative to said housing, providing at least one heating element associated with one of said housing and said lid, operating the at least one heating element to cook food in a conduction cooking mode, and operating the at least one heating element to cook food in a thermal radiation cooking mode.

In addition to one or more of the features described above, or as an alternative, in further embodiments said operating in said conduction cooking mode includes operating said at least one heating element to at least one of pressure cook, steam, slow cook, searing, and sauté food, and wherein said operating in said thermal radiation cooking mode includes operating said at least one heating element to at least one of air fry, bake, roast, broil, and dehydrator the food.

In addition to one or more of the features described above, or as an alternative, in further embodiments comprising receiving a food container receivable in said hollow interior, and operating the at least one heating element to cook food in said food container in both said conduction cooking mode and said thermal radiation cooking mode.

In addition to one or more of the features described above, or as an alternative, in further embodiments comprising disposing food in contact with a container surface of said food container, and operating the at least one heating element to cook said food disposed in contact with said container surface in both said conduction cooking mode and said thermal radiation cooking mode.

In addition to one or more of the features described above, or as an alternative, in further embodiments the at least one heating element is a first heating element and second heating element, the method further including operating the first heating element to conductively heat said container surface to cook food, and operating the second heating element to thermally radiate an interior of said food container to cook food from an area at or above an opening at an upper extent of said food container.

In addition to one or more of the features described above, or as an alternative, in further embodiments said second heating element is disposed said lid.

In addition to one or more of the features described above, or as an alternative, in further embodiments comprising sensing temperature via a first temperature sensor proximate said first heating element and a second heating sensor in said lid.

In addition to one or more of the features described above, or as an alternative, in further embodiments comprising selectively sealing said hollow interior via a second lid.

In addition to one or more of the features described above, or as an alternative, in further embodiments said selectively sealing via said second lid occurs when said first lid is in an open position.

In addition to one or more of the features described above, or as an alternative, in further embodiments said selectively sealing via said second lid occurs during said operating in said conduction cooking mode.

In addition to one or more of the features described above, or as an alternative, in further embodiments comprising installing an insert within said food container.

In addition to one or more of the features described above, or as an alternative, in further embodiments comprising supporting food in or on said insert disposed in said food container in said thermal radiation cooking mode.

In addition to one or more of the features described above, or as an alternative, in further embodiments comprising supporting food in or on an insert disposed in said food container during said thermal radiation cooking mode and said conduction cooking mode.

In addition to one or more of the features described above, or as an alternative, in further embodiments said insert includes a body with a base with an aperture pattern at one end and an open end at an opposing end, the method further including forming an annulus between an inner wall of said food container and an outer wall of said body.

In addition to one or more of the features described above, or as an alternative, in further embodiments comprising transforming the system from said conduction cooking mode and said thermal radiation cooking mode without removing a particular food item from said hollow interior.

In addition to one or more of the features described above, or as an alternative, in further embodiments said operating said at least one heating element to cook food in said thermal radiation cooking mode includes emitting thermal radiation from said at least one heating element.

In addition to one or more of the features described above, or as an alternative, in further embodiments said thermal radiation includes electromagnetic waves having an infrared wavelength.

In addition to one or more of the features described above, or as an alternative, in further embodiments said thermal radiation includes electromagnetic waves having a visible light wavelength.

In addition to one or more of the features described above, or as an alternative, in further embodiments said thermal radiation includes electromagnetic waves having an ultraviolet wavelength.

In addition to one or more of the features described above, or as an alternative, in further embodiments said thermal radiation includes microwaves.

In addition to one or more of the features described above, or as an alternative, in further embodiments said thermal radiation includes radio waves.

In addition to one or more of the features described above, or as an alternative, in further embodiments comprising redirecting said thermal radiation via a reflector.

In addition to one or more of the features described above, or as an alternative, in further embodiments said reflector is contoured to direct thermal radiation towards a specific region of said enclosure.

In addition to one or more of the features described above, or as an alternative, in further embodiments said food container includes a container surface, and said container surface is said reflector.

In addition to one or more of the features described above, or as an alternative, in further embodiments said reflector is connected to said lid.

In addition to one or more of the features described above, or as an alternative, in further embodiments comprising an insert receivable within said food container, wherein said reflector is connected to said insert, or said insert is said reflector.

### BRIEF DESCRIPTION OF THE FIGURES

The accompanying drawings incorporated in and forming a part of the specification embodies several aspects of the present disclosure and, together with the description, serves to explain the principles of the disclosure. In the drawings:

FIG. 1A is a perspective front view of the cooking system according to an embodiment;

FIG. 1B is a bottom view of the cooking system according to an embodiment;

FIG. 1C is a side by side front view the cooking system according to an embodiment;

FIG. 1D is a rear view of the cooking system according to an embodiment;

FIG. 2 is a perspective view of the cooking system having a lid in an open position according to an embodiment;

FIG. 3A is a cross-sectional view of the cooking system having a secondary lid according to an embodiment;

FIG. 3B is a front view of a cooking system having a secondary lid according to an embodiment;

FIG. 3C is a lower view of a lid of the cooking system according to an embodiment;

FIG. 4 is a perspective view of a cooking system having both a lid and a secondary lid in an open position according to an embodiment;

FIG. 5 is a perspective view of a cooking system having both a lid and a secondary lid in a closed position according to an embodiment;

FIG. 6A is a perspective view of a lid of the cooking system according to an embodiment;

FIG. 6B is another perspective view of a lid of the cooking system according to an embodiment;

FIG. 7 is a schematic diagram of the cooking system according to an embodiment;

FIG. 8 is a perspective view of a cooking system having an insert positioned therein according to an embodiment; and

FIG. 9 is a cross-sectional view of the cooking system according to an embodiment;

FIG. 10 is a block diagram illustrating a control path for a cooking system according to an embodiment;

FIG. 11 is a perspective view of the cooking system having a lid in an open position according to an embodiment;

FIG. 12 is a table showing cooking parameters for use in a cooking system according to an embodiment;

FIG. 13 is a circuit diagram for use in a cooking system according to an embodiment;

FIG. 14 is a logic diagram for use in a cooking system according to an embodiment;

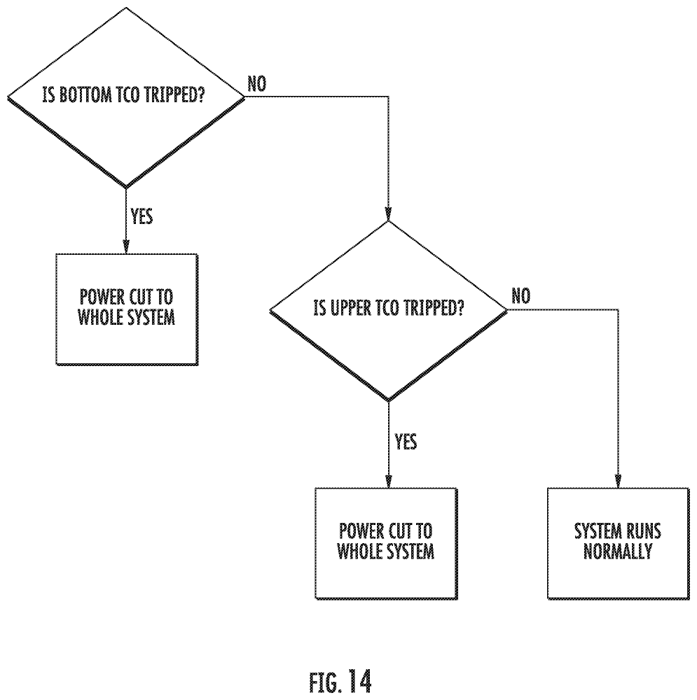

FIGS. 15A-D is an upper view of a series of lid positions in a cooking system according to an embodiment; and

FIG. 16 is a schematic diagram of the cooking system according to an embodiment.

The detailed description explains embodiments of the disclosure, together with advantages and features, by way of example with reference to the drawings.

### DETAILED DESCRIPTION

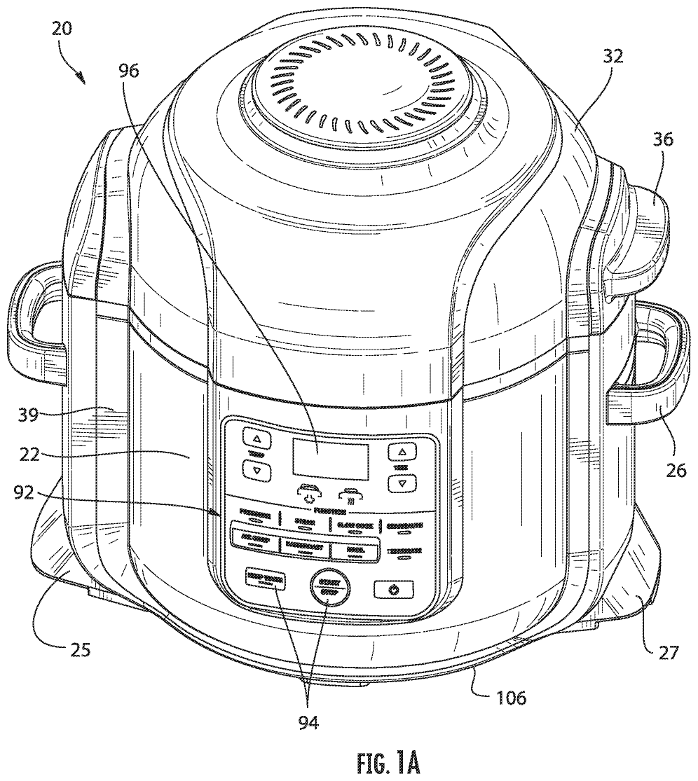

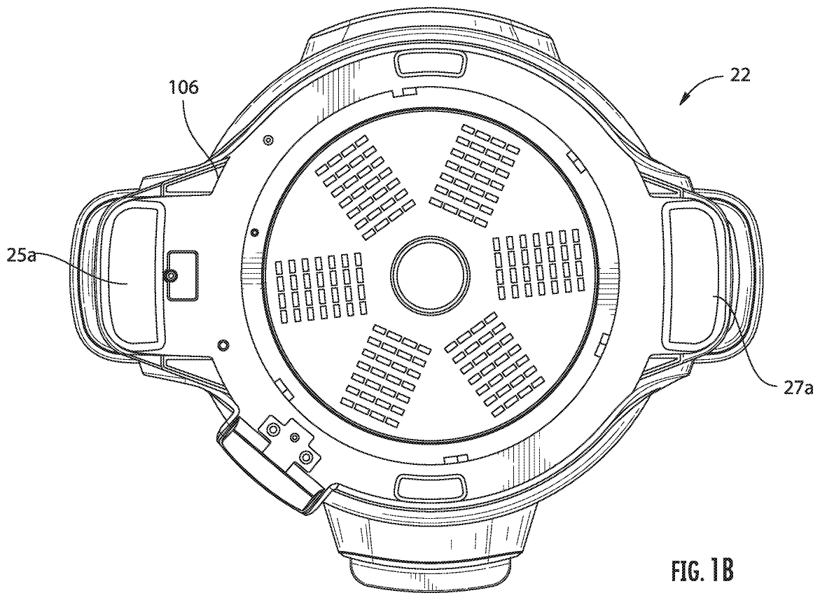

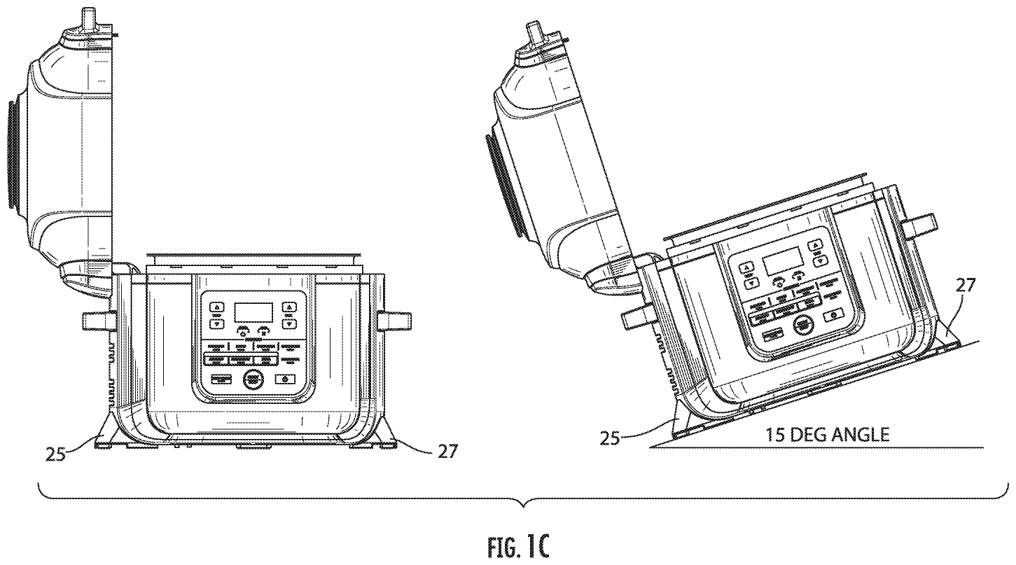

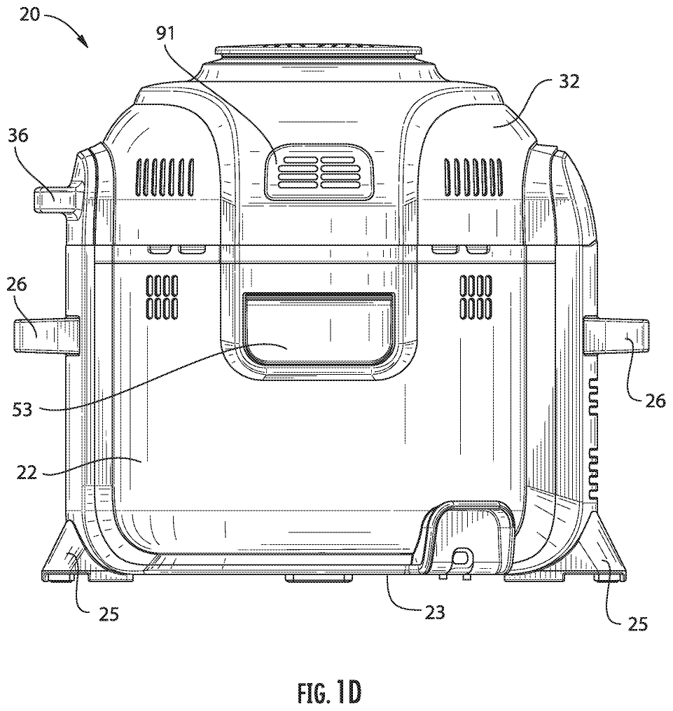

With reference first to FIGS. 1-7 and 16, a cooking system 20 configured to perform multiple cooking operations is illustrated. As shown, the cooking system 20 includes a housing 22 and a first or primary lid 32 permanently or removably attached, or more specifically hinged, to the housing 22. In an exemplary, non-limiting embodiment, the connection or hinge area between the lid 32 and the housing 22 occurs at an upper portion of a spine 39 of the housing 22. A bottom 106 of the housing 22 of the cooking system 20 (see FIG. 1B) may be supported on a surface by one or more feet 25 and 27, which may include shock absorbing pads 25a and 27a (of a material such as but not limited to rubber) at a bottom surface thereof. The feet 25, 27 may extend from the housing 22 to define a surface on which the cooking system 20 may contact an adjacent supporting surface, such as a countertop for example. The bottom surface of the feet 25, 27 or pads 25a, 27a may be flush with, or alternatively, may extend out of plane from the bottom 106 of the housing. In the illustrated, non-limiting embodiment, the housing 22 includes two feet 25, 27 arranged on opposing sides of the housing 22; however, it should be understood that a housing having any suitable number of feet 25 is within the scope of the disclosure.

Further, in the exemplary, non-limiting embodiment shown in at least FIGS. 1A-C, the foot 25 under the spine 39 is larger and extends out a greater distance from the side of the housing 22 than the foot 27. As shown in FIG. 1C, this allows for better support of the system 20 when the cooking system 20 is on a substantially flat surface or an inclined surface (up to 15 degrees in an exemplary embodiment) and the relatively heavy lid 32 is in an open position.

In the illustrated, non-limiting embodiment, one or more handles 26 extend outwardly from the exterior of the housing 22 to provide a user with a location to more easily grasp the system 20. Although two handles 26 are shown, embodiments having no handles, a single handle, or more than two handles are also within the scope of the disclosure. The housing 22 and/or the one or more handles 26 may be integrally or separately formed, such as from a molded plastic material for example. Referring now to some of the interior features of the system 20, an inner surface of the housing 22 defines a hollow interior 30. In an exemplary non-limiting embodiment, a liner 23 that may be formed from any suitable conductive material, such as aluminum for example is disposed within the hollow interior 30, and in some embodiments the liner 23 may be the inner surface defining the hollow interior (though surfaces inside the liner 23, such as the walls of the container, or outside the liner 23, such as plastic around the liner 23, may also define the hollow interior 30).

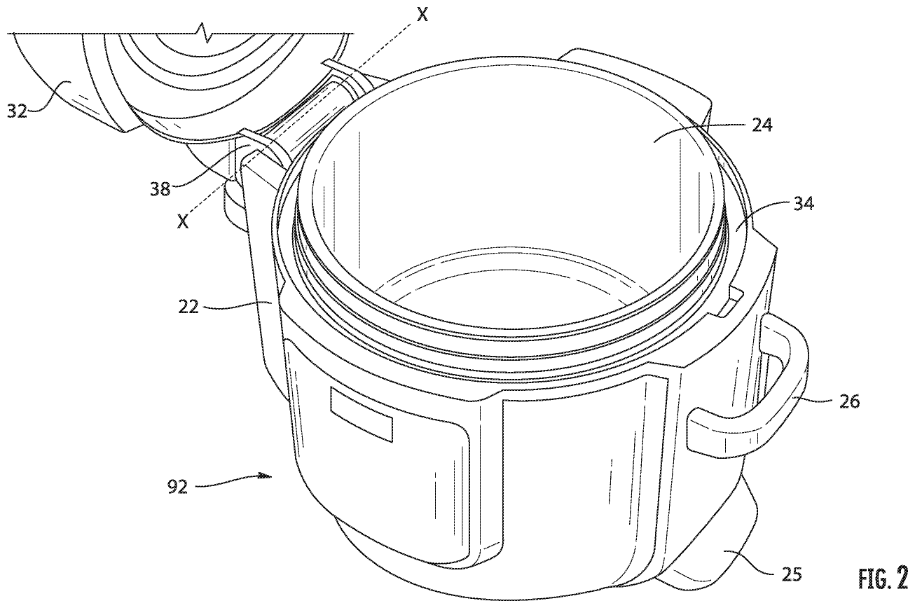

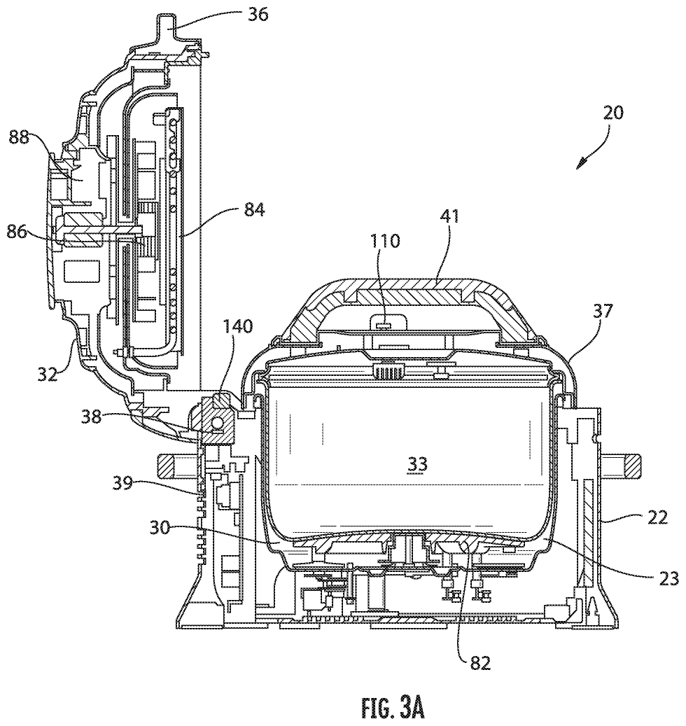

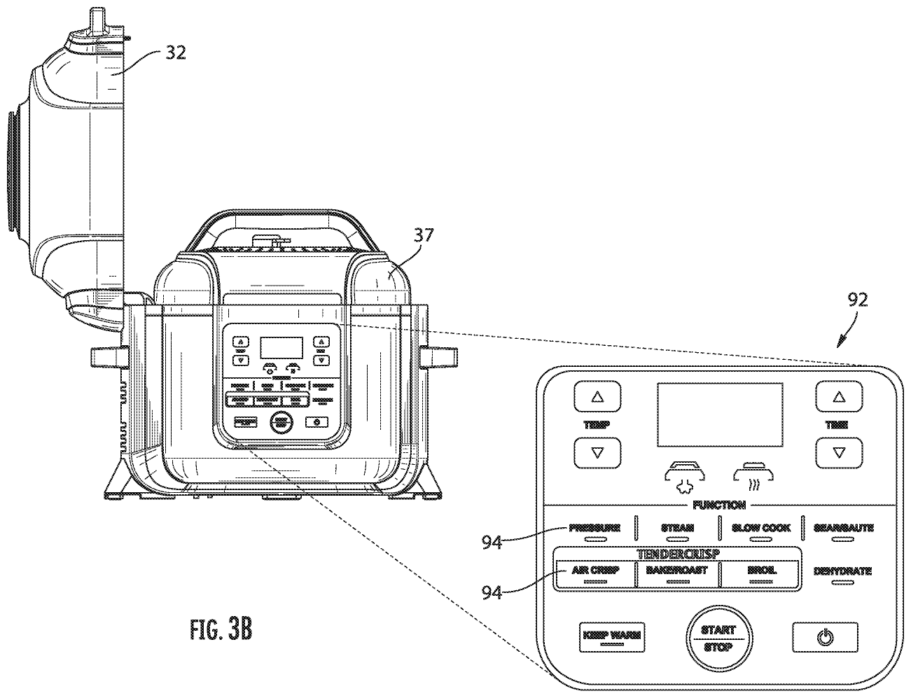

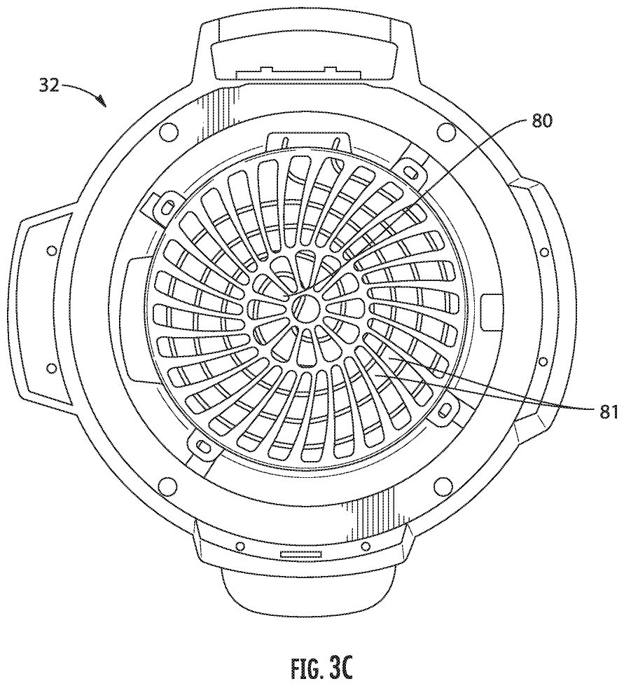

In an exemplary, non-limiting embodiment, a food container 24 is receivable inside the hollow interior 30 defined by the liner 23. Spacing components, such as silicone bumpers (not shown) may be disposed along the inner surface of the liner 23 to keep the container 24 aligned properly within the hollow interior 30 during cooking. Although the container 24 is described herein as being removable from the housing 22, embodiments where the container 24 is integrally formed with the housing 22 are also contemplated herein. The container 24, which is shown in FIGS. 2 and 3A, has an interior 33 designed to receive and retain one or more consumable products, such as food products for example, therein. Examples of food products suitable for use with the cooking system 20, include but are not limited to, meats, fish, poultry, bread, rice, grains, pasta, vegetables, fruits, and dairy products, among others. The container 24 may be a pot formed from a ceramic, metal, or die cast aluminum material. In an embodiment, an interior surface of the container 24 includes a material or coating that desirably reflects or absorbs thermal. radiation, and an exterior surface of the container 24 includes a silicone epoxy material. However, any suitable material capable of withstanding the high temperatures and pressures required for cooking food products is contemplated herein.

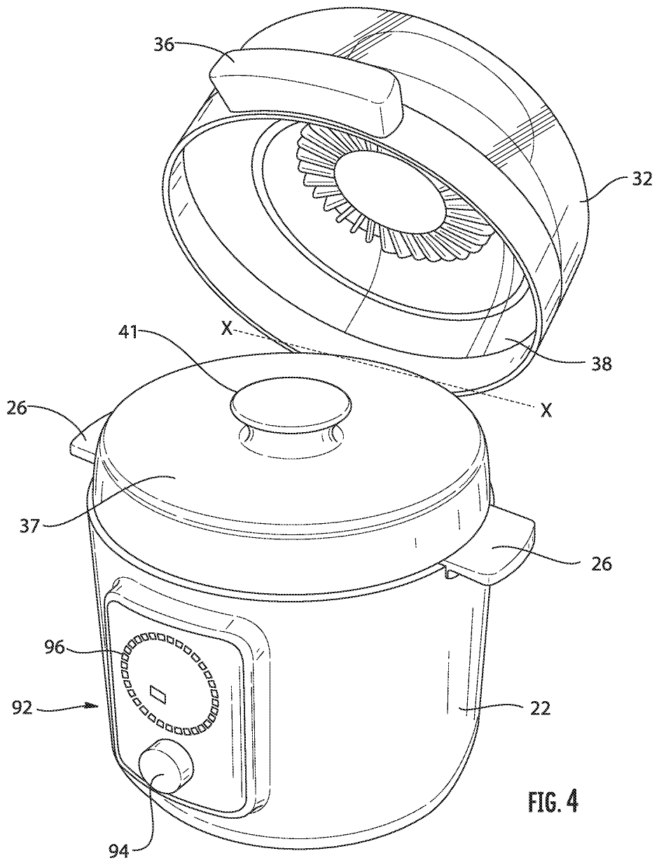

Referring with more detail to the lid 32, it should be noted that the lid 32 is connectable to a surface of the container 24 and/or housing 22 to close off entry to the hollow interior 30 of the container 24. In an embodiment, a diameter of the lid 32 is generally complementary to a diameter of the housing 22 such that the lid 32 covers not only the container 24, but also an upper surface 34 of the housing 22. The lid 32 can be made of any suitable material, such as glass, aluminum, plastic, or stainless steel for example. Further, the lid 32 may, but need not, include one or more handles 36 for removably coupling the lid 32 to the remainder of the cooking system 20. In the illustrated, non-limiting embodiment, the lid 32 is coupled to the housing 22 via a hinge 38 (best shown in FIG. 3A just above the spine 39), such that the lid 32 is rotatable about an axis X between an open position (FIG. 3) and a closed position (FIG. 1A). In such embodiments, the hinge axis X may be located at a side surface of the cooking system 20, as shown in FIG. 2, or alternatively, at a back surface of the cooking system 20, such as vertically disposed relative to one or more handles 26 of the housing 22, as shown in FIG. 4. However, embodiments where the lid 32 is separable from the housing 22, or movable between the open and closed positions in another manner are also contemplated herein. One or more fastening mechanisms (not shown) may, but need not be used to secure the lid 32 to the housing when the lid 32 is in the closed position. Any suitable type of fastening mechanism capable of withstanding the heat associated with the cooking system 20 is considered within the scope of the disclosure.

In an embodiment, best shown in FIGS. 3A-C, 4-5, and 6A-B, the cooking system 20 additionally includes a secondary lid 37 configured to removably couple to the housing 22 and/or container 24 to seal the hollow interior 30. In an embodiment, the secondary lid 37 is press-fit onto an upper surface 34 of the housing 22 or directly to the container 24. In another embodiment, the secondary lid 37 is configured to thread-ably couple to the upper surface 34 of the housing 22 or the container 24. However, embodiments where the secondary lid 37 is configured to couple to at least one of the housing 22 and container 24 in another suitable manner, such as via a pressure tight mechanism for example, are also contemplated herein. The secondary lid 37 can be made of any suitable material, such as glass, aluminum, plastic, or stainless steel, or any combination thereof for example. In an embodiment, the secondary lid 37 is formed from a molded plastic material. In addition, the secondary lid 37 may, but need not, include one or more handles 41 for removably coupling the secondary lid 37 to the cooking system 20. The handle 41 may be integrally formed with the remainder of the lid 3′7, such as via a molding process, or alternatively, may be a separate component coupled to the lid 37.

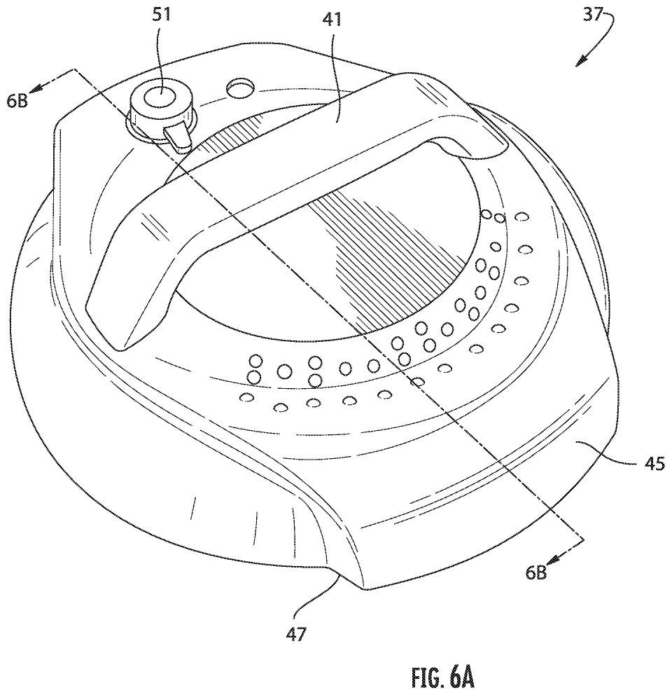

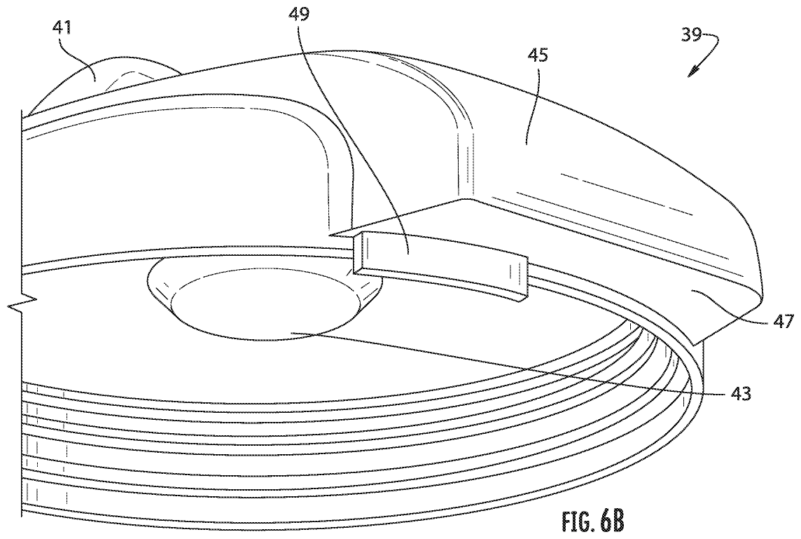

As best shown in FIG. 6B, the secondary lid 37 includes an interior liner 43, also referred to as an “underliner” formed from any suitable material, such as stainless steel for example. In an embodiment, one or more threads may be formed in the underliner 43 to couple the lid 37 to an end of the container 24. As shown, the lid 37 may additionally include a lid support ring 45 having a diameter extending beyond the outer diameter of the underliner 43 about at least a portion of the circumference thereof. In an embodiment, a surface 47 of the lid support ring 45 may be configured to abut the upper surface 34 of the housing 22 when the secondary lid 37 is coupled to the container 24. A lid cushion 49, such as formed from a resilient or elastomeric material, such as rubber for example, may be disposed at an exterior surface of a portion of the lid 37, such as between the under-liner 43 and the lid support ring 45 for example. Further, a pressure relief valve 51 (see FIG. 6A) is formed in a surface of the secondary lid, such as the upper surface thereof for example. The pressure relief valve is configured to automatically open to release air from within the chamber formed between the secondary lid 37 and the container 24 when the pressure therein exceeds a predetermined threshold. Alternatively, or in addition, the pressure relief valve is manually operable to release air from within the chamber formed between the secondary lid 37 and the container 24.

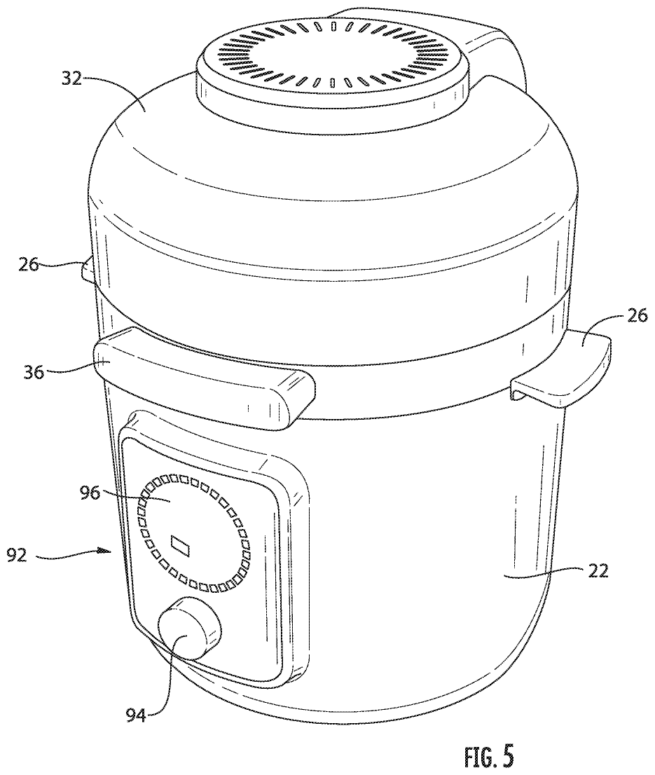

To couple the secondary lid 37 to the housing 22, the primary lid 32 must be in an open position, as shown in FIGS. 3A and 3B. Further, in an embodiment, the primary lid 3:2 is not movable to the closed position relative to the housing 22 when the secondary lid 37 is affixed thereto. This may be due to the outer diameter of the secondary lid 37, or alternatively, because one or more components extending upwardly from the lid 37, such as handle 41, would interfere with a portion of the primary lid 32. However, in other embodiments, as shown in FIGS. 4 and 5, at least a portion of the secondary lid 37 may be nestable or receivable within the primary lid 32. In such embodiments, the outer diameter of the secondary lid 37 may be smaller than the inner diameter of the primary lid 32, such that the primary lid 32 substantially surrounds the secondary lid 37 when in the closed position. Accordingly, the enclosure defined by the hollow interior 30 of the container 24 and the secondary lid 37 is smaller than the enclosure formed by the hollow interior 30 of the container 24 and the primary lid 32. Although the cooking system 20 is illustrated and described herein including the secondary lid 37, it should be understood that in some embodiments the cooking system 20 includes only a primary lid 32 and does not include a secondary lid 37.

With reference again to FIG. 2, a condensation rim may be formed in the upper surface 34 of the housing 22, radially outward of the opening and/or container 24. During operation of the cooking system 20, condensation or other fluid circulating within the container 24 and/or hollowed interior 30 of the system 20 may collect within the condensation rim. In an embodiment, best shown in FIG. 1D, a condensation tray 53 is arranged in communication with the interior 30 of the container 24. The condensation tray 53, may, but need not, be arranged in fluid communication with the condensation rim of the upper surface 34. As shown, the condensation tray 53 is accessible via the back surface of the housing 22 and is configured to removably couple to the housing 22 to allow a user to empty the contents of the tray 53. When connected to the housing 22, the condensation tray 53 may be suitable to form a pressure tight seal with the housing 22.

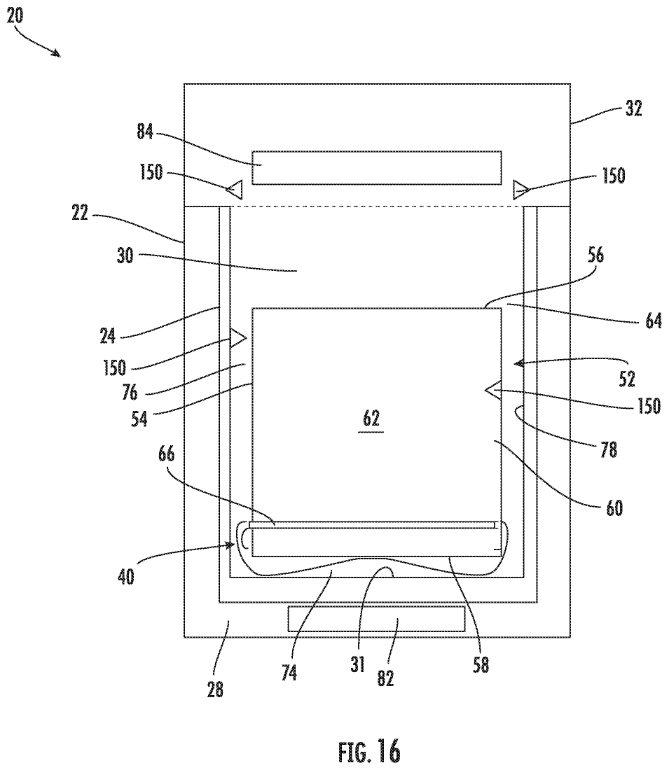

With reference now to FIG. 16, an optional diffuser 40 and optional frying insert 52 are shown. The diffuser 40 is an optional system component that is positionable anywhere in the hollow interior 30 (though typically near the bottom) to redirect heat, in particular heat in the form of thermal radiation. In an exemplary, non-limiting embodiment, the diffuser 40 is positioned in contact with a bottom surface 31 the container 24, and, perhaps, used in conjunction with the insert 52.

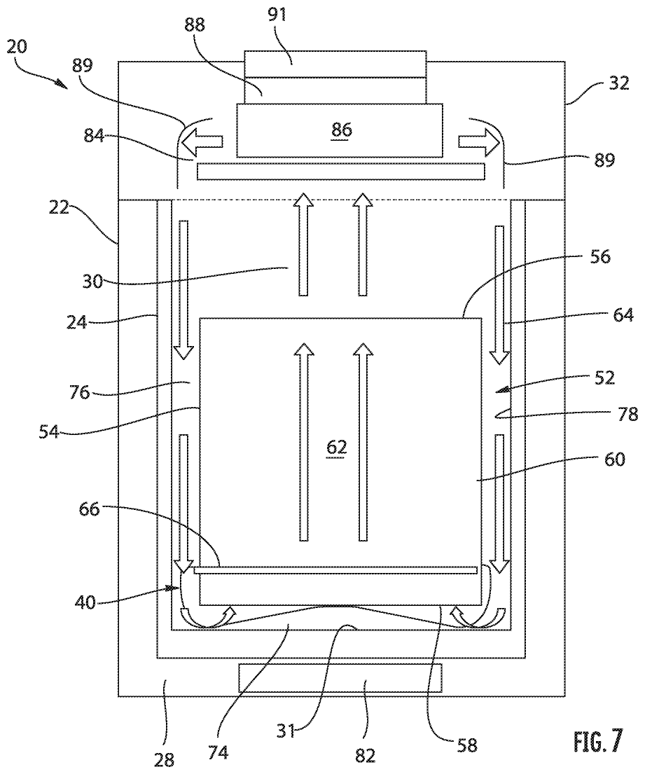

As best shown in FIG. 7, the cooking system 20 includes at least one first heating element 82 and at least one second heating element 84 configured to impart heat to the hollow interior and/or container 24 during various modes of operation of the cooking system 20. As shown, a first heating element 82 may be disposed at the base 28 of the housing 22, generally adjacent the bottom 31 of the container 24; though, embodiments where one or more of the first heating elements 82 are arranged adjacent a side of the housing 22, in addition to or in place of the base 28 of the housing 22, are also contemplated herein. One or more second heating elements 84 may be positioned generally at or above an upper extent of the container 24, proximate an upper opening of the container 24. However, in the exemplary non-limiting embodiment shown in the Figures, the second heating element 84 is disposed in the lid 32, and therefore completely outside of the container 24, above the upper extent thereof. Although only a single second heating element 84 is illustrated, it should be understood that embodiments including a plurality of second heating elements 84 are within the scope of the disclosure. Further, the plurality of second heating elements may have similar or different constructions, and may be located within the same portion or different portions of the cooking system 20.

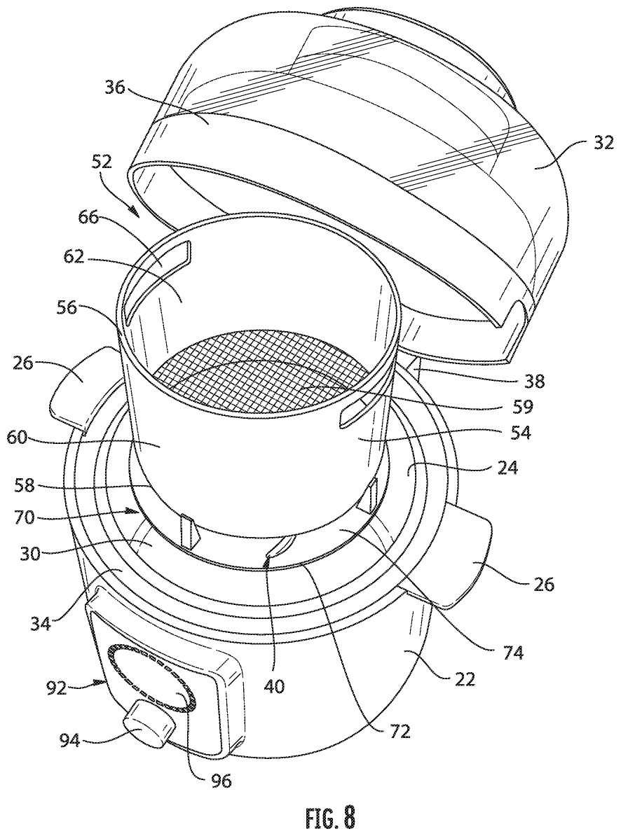

With reference again to FIGS. 1A, 4, 5, and reference to FIG. 8, a control panel or user interface 92 of the cooking system 20 is positioned adjacent one or more sides of the housing 22. The control panel 92 includes one or more inputs 94 associated with energizing the one or more heating elements 82, 84 of the cooking system 20 and for selecting various modes of operation of the cooking system 20. One or more of the inputs 94 may include a light or other indicator to show that the respective input has been selected. The control panel 92 may additionally include a display 96 separate from and associated with the at least one input 94. However, embodiments where the display 96 is integrated into the at least one input 94 are also contemplated herein.

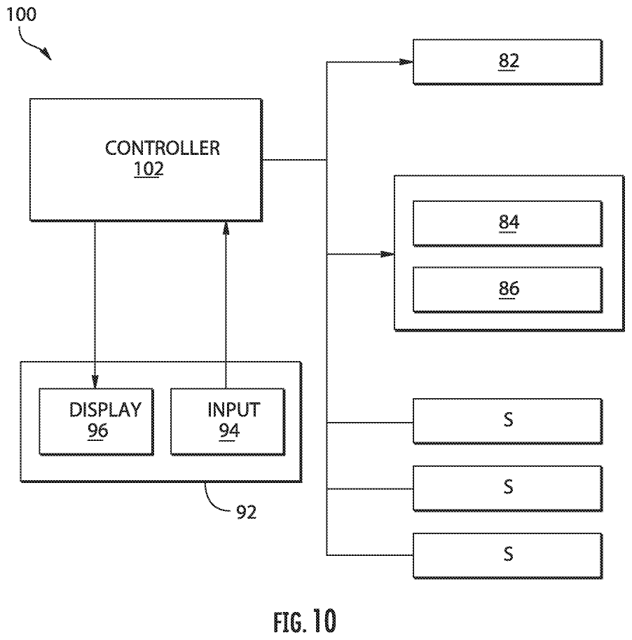

Operation of the one or more inputs 94 will be described in more detail below. As shown in FIG. 10, a control system 100 of the cooking system 20 includes a controller or processor 102 for controlling operation of the heating elements 82, 84, and in some embodiments for executing stored sequences of heating operation. The processor 102 is operably coupled to the control panel 92 and to the heating elements 82. In addition, in an exemplary embodiment, one or more sensors S for monitoring one or more parameters (such as temperature, pressure, lid configuration, etc.) associated with operation of the heating elements 82, 84 and/or lids 32, 37 may be arranged in communication with the processor 102. In an embodiment, a first temperature sensor extends from a bottom surface 108 of the liner 23 proximate the first heating element 82 and bottom surface of the container 24, and a second temperature sensor is located within the lid 32 proximate the second heating element 84. In such embodiments, the second sensor may be used, such as to monitor temperature for example, when the lid 32 is closed and the sensor S is arranged in fluid communication with the hollow interior 30 of the system 20. The first sensor may be used to monitor temperature in this manner, separately or in conjunction with the second temperature sensor.

In an embodiment, at least one input 94 on the control panel 92 is an on/off button which allows the user to activate or deactivate the control panel 92. When the control panel 92 is deactivated, none of the heating elements 82, 84 are energized. In an exemplary embodiment, the at least one input 94 is operable to select one or more manual modes of operation of at least one of the heating elements 82, 84. Alternatively, or in addition, at least one input 94 is operable to select a stored sequence of operation of at least one heating element 82, 84. In some cases, the stored sequences may be particularly well suited for a given method of food preparation and/or for particular ingredients or types of ingredients. The plurality of stored sequences associated with the at least one input 94 may be stored within a memory accessible by the processor 102. Alternatively, the plurality of stored sequences may be stored remotely from the cooking system 20, and may be accessed by the processor 102, such as via wireless communication for example.

In addition, a user may be able to enter a time associated with operation of the cooking system 20 in a desired manual mode. The time may be entered via the same input, or a separate input as used to select a mode of operation. Further in embodiments where the system 20 is in a mode configured to perform a stored sequence in response to selection of one of the inputs 94, the display 96 may indicate a time remaining on the display. Temperature and pressure parameters may also be entered via inputs 94.

The at least one input 94 may include a distinct start button intended to initiate operation in a desired mode, a distinct stop button to cease all operation, or a stop/start button intended to initiate and cease functions. Alternatively, the cooking system 20 may be operable to automatically start operation after a predetermined time has elapsed once an input has been selected and any necessary information has been provided to the control panel. Alternatively, one or more of the other inputs 94, such as the knob for example, may be operable, such as by pushing the knob towards the control panel 92, to start and stop operation of the cooking system 20, regardless of whether the system 20 is following a stored sequence or is in a manual mode.

The one or more inputs 94 are operable to initiate manual operation of the cooking system 20 in at least a first cooking mode and a second cooking mode. In an embodiment, the first cooking mode employs the at least one first heating element 82 to perform conductive cooking operations. Conductive cooking operations may generally be referred to as “wet cooking” operations, such as but not limited to pressure cooking, steam cooking, slow cooking, searing, and sautéing. To create a wet cooking environment the majority of the moisture within the container, i.e. liquid added to the container 24 or moisture released from the food within the container 24, is retained within the container 24 as the food is cooked. Although during conductive cooking operations a minimal amount of air having moisture entrained therein may be vented from the system, such air is passively removed from the cooking enclosure.

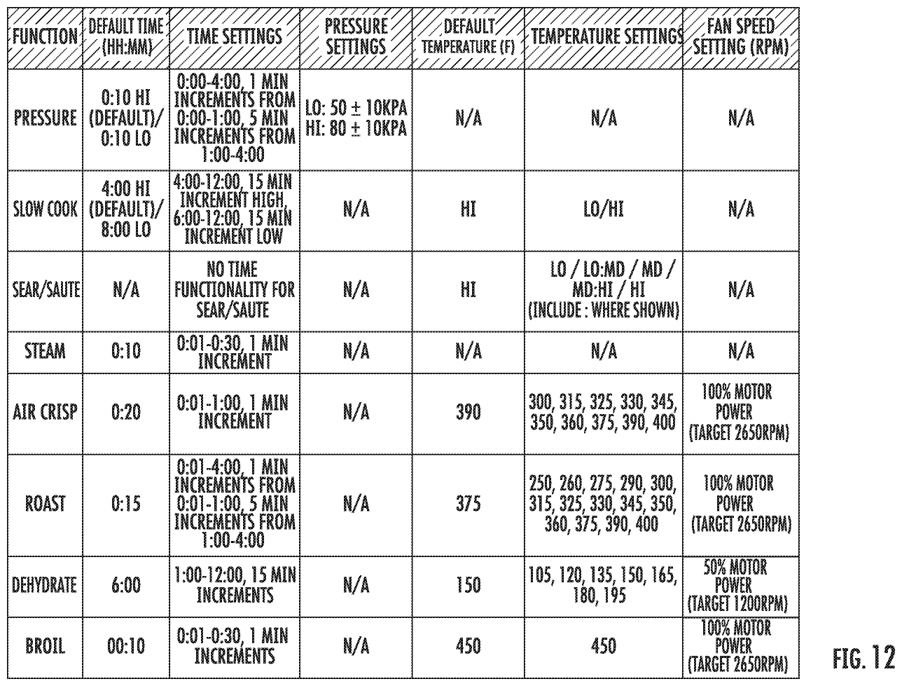

Similarly, the second cooking mode employs one or more second heating elements 84 to perform thermal radiation cooking operations. Thermal radiation, or radiant heat, as used herein includes the transfer of energy by means of photons in electromagnetic waves. Thermal radiation occurs within a vacuum or any transparent medium (solid, fluid, or gas) and therefore does not require any intervening medium to carry the electromagnetic waves. Accordingly, direct or indirect contact between the food being cooked and the second heating element 84 is not required. Additionally, in some embodiments the heat need not be moved within, towards, or away from the liner 23 or container 24. Examples of thermal radiation cooking operations include, but are not limited to air frying, broiling, baking/roasting, heating, toasting, defrosting, and dehydrating. Parameters associated with the various exemplary but non-limiting cooking modes are shown at FIG. 12.

As is noted above, the first cooking mode of the cooking system 20 includes pressure cooking. In such embodiments, the secondary lid 37 is affixed to the container 24 or housing 22 to form a pressure-tight, sealed enclosure with the container 24. During operation in the pressure cooker mode, the controller 102 initiates operation of the first heating element 82, causing the temperature and therefore the pressure, within the enclosure formed by the container 24 and the secondary lid 37 to rise. During operation in the pressure cooker mode, the second heating element 84 disposed within the primary lid 32 is typically not energized. In an embodiment, the cooking system 20 may include a sensor S configured to monitor the pressure within the enclosure. Upon detection that the pressure is at or exceeds a predetermined threshold, the controller 102 may de-energize the heating element 82 until the pressure within the enclosure has returned to an acceptable level.

Alternatively, or in addition, a pressure relief valve 51 (see FIG. 6A) may be formed in the secondary lid 37 and may open to reduce the pressure within the enclosure to below the threshold. The pressure relief valve 51 may be configured to open automatically when the pressure is above the threshold, or the valve 51 may be coupled to the controller 102 and may be operable in response to a signal generated by the controller 102, for example in response to sensing a pressure above the threshold. In embodiments where the cooking system 20 is operable in a slow cooking mode, but not a pressure cooking mode, the liner 23 of the housing 22 may be formed from a light weight, cost effective material, such as aluminum for example. However, in embodiments where the cooking system 20 is operable in a pressure cooking mode, the liner 23 should be formed from a more rigid material capable of withstanding the pressure build up within the container 24. As is noted above, the first cooking mode of the cooking system 20 also includes slow cooking, steaming, searing, and sautéing. When the cooking system 20 is operated in one of these non-pressure modes, either the secondary lid 37 may be affixed to the container 24 or housing 22 or the primary lid 32 may simply be closed.

During slow cooking, steaming, searing, and sautéing (or other conductive cooking means that do not involve “pressure cooking”), the controller 102 initiates operation of one or more first heating elements 82, causing the temperature within the container 24 and at the bottom surface thereof to increase. Upon detection that the temperature of the chamber 30 is equal to or exceeds a predetermined threshold, the controller 102 may de-energize the heating element 82 until the temperature has returned to an acceptable level. Such de-energization or power termination to the heating elements 82 and 84 based on detection of unsafe conditions by temperature or pressure sensors S will be discussed in greater detail below.

As previously suggested, the at least one input 94 is also usable to select operation of the cooking system 20 in a second cooking mode that uses thermal radiation to perform a cooking operation. In the second thermal radiation cooking mode, at least one second heating element 84 is operable to emit thermal radiation toward the surface of the food located within the enclosure defined between the primary lid 32 and the container 24. The thermal radiation is emitted by a heated surface of the second heating element 84 in all directions and travels directly to a point of absorption at the speed of light. In an embodiment, the second heating element 84 is operable to emit thermal radiation or radiant heat at infrared wavelengths. However, embodiments where the second heating element 84 is able to emit thermal radiation having a wavelength associated with visible light, microwaves, ultraviolet light, or radio waves are also within the scope of the disclosure. In some embodiments, the second heating element 84 is operable to emit electromagnetic waves of varying wavelengths.

The second heating element 84 may have a diameter substantially equal to the diameter of the body 54 of the insert 52. However, embodiments where the second heating element 84 has a diameter smaller than or greater than the diameter of the body 54 of the insert 52 are also contemplated herein. Although the at least one second heat element 84 is illustrated and described herein as being configured to emit thermal radiation, it should be understood that embodiments where the first heating element 82 is a radiative heating element operable to emit thermal radiation are also contemplated herein. Further, any suitable type of heating element capable of emitting thermal radiation is considered within scope of the disclosure.

With reference now to FIG. 16, in an embodiment, one or more reflectors 150 are arranged within the enclosure defined by the lid 32 and the container 24. The term “reflector” is intended to include any component formed from a material or including a coating or surface having a high reflectivity or low emissivity such that a majority of the electromagnetic waves that contact the surface of the reflector are radiated or reflected therefrom back toward the interior of the container 24. Accordingly, the amount of thermal radiation absorbed by a surface having a high reflectivity is limited. Examples of suitable food safe materials having a high reflectivity include, but are not limited to, metal, foil, glass, paper, cardboard and many polymeric materials. Further, in an embodiment, the reflectors 150 may have a silver surface, which is known to have a low emissivity.

The one or more reflectors 150 may be separate components affixed to one or more of: a surface of the primary lid 32, an interior surface of the container 24, a portion of the insert 52 (if an insert is used), and a surface of the diffuser 40 (if used). Alternatively, or in addition, the inner surface 78 of the container 24 may be configured as a reflector 150. The one or more reflectors 150 of the cooking system 20 may be positioned and contoured to facilitate uniform distribution of the thermal radiation throughout the enclosure resulting in more evenly cooked food. In embodiments where the inner surface 78 of the container 24 functions as a reflector 150, a contour of the inner surface 78 may be designed to redirect thermal radiation towards a specific area or region within the enclosure.

In an embodiment, the energy or electricity delivered to the one or more second heating elements 84 may vary depending on the type of cooking operation being performed in the second thermal radiation cooking mode. For example, during a baking operation, the amount of thermal radiation generated by the second heating element 84 may be controlled to prevent the surface of the food from burning before the interior of the food is adequately baked. However, during a toasting or broiling operation, where an exterior food surface is intended to be cooked more than an interior food surface, the intensity of the thermal radiation may be held generally constant for the limited time of the cooking operation to achieve the desired browning or crisping of the food.

When utilizing the at least one second heating element 84 in the air fryer mode, the controller 102 initiates operation of the second heating element 84. The thermal radiation emitted from the radiative heating element is applied to the adjacent surface of food within the container. In addition, the thermal radiation or radiant heat may be redirected via the one or more reflectors 150 to interact with a surface of the food not directly facing the second heating element 84. Reflectors 150 positioned about contours of the container 24 (particularly at the bottom surface thereof), and insert 52 if used (again particularly at the bottom thereof) may be used to redirect thermal radiation towards surfaces of the food not directly facing the second heating element 84. The diffuser 40 may also be used to reflect thermal radiation in this manner. As thermal radiation is emitted into and reflected throughout the enclosure as described above, the radiant energy cooks and forms a crispy outer layer on the food items disposed therein. Alternatively, or in addition, adjustment of the food within the enclosure may be performed to uniformly distribute the thermal radiation over the food surface. Examples of adjustment of the food item include but are not limited to agitation and rotation or flipping. During operation in the air fryer mode, the first heating element 82 is generally not energized. However, embodiments where the first heating element 82 is energized are also within the scope of the disclosure.

As is best shown in FIG. 3C, in an exemplary embodiment the lid 32 includes a cover 80 that protects a user from the at least one heating element 84, and protects the heating element 84 from the areas 31,33,64 where food is cooked. The cover 80 may be included in embodiments of the cooking system 20 including only a primary lid 32, or alternatively, in embodiments including both the primary and secondary lids 32, 37. In the illustrated, non-limiting embodiment, the cover 80 is formed from a nano-ceramic coating and is mounted to the primary lid 32, such as via one or more fasteners for example. In such embodiments, when the primary lid 32 is in the closed position, the cover 80 is arranged generally above the first open end of the container 24. The cover 80 has a plurality of openings 81 formed therein to allow thermal radiation, and in some embodiments hot air circulating within the chamber of the container 24, to pass there through.

In another thermal radiation cooking embodiment, the second cooking mode of the cooking system 20 includes a dehydrator mode, such as used to make jerky for example. In such embodiments, the primary lid 32, is typically affixed to the container 24 or housing 22, though the secondary lid 32 may also be used. When the cooking device 20 is operated in the dehydration mode, the air diffuser 40 and/or insert 52 may, but need not be, positioned within the interior 30 of the container 24. During operation in the dehydrator mode, thermal radiation is emitted throughout the container 24 in a manner similar to the air fryer mode.

In an embodiment, during operation in the second cooking mode, convective or conductive cooking may also be performed in addition to the thermal radiation cooking. In such embodiments, such as when the cooking system 20 additionally performs convective cooking in the second cooking mode, various other components of the cooking system 20, for example, an air movement device 86 and/or the diffuser 40 (see FIG. 7) may be operable. The air movement device 86, such as a fan for example, is operational to circulate air, heat, or steam within the enclosure. In an embodiment, a single second heating element 84 may be used for both thermal radiation and convection heating. Alternatively, one second heating element 84 may be used to generate thermal radiation and another, distinct second heating element 84 may heat air circulated there through to perform convective heating.

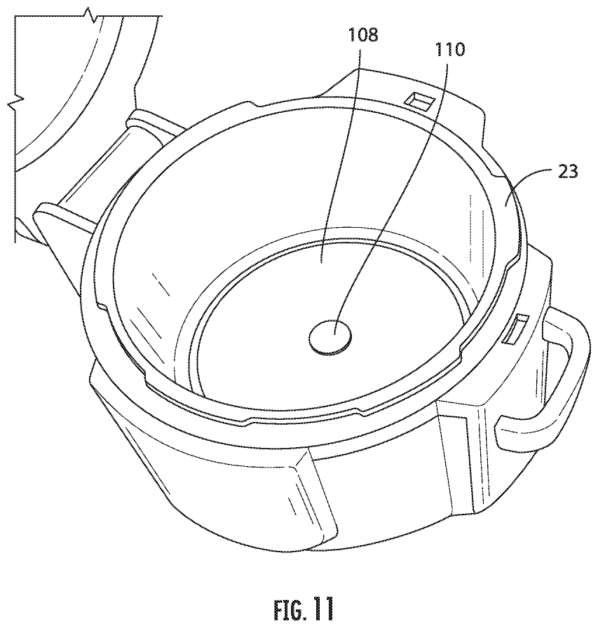

In the illustrated, non-limiting embodiment of FIGS. 7 and 11, the air movement device 86 is driven by a motor 88 having a separate cooling mechanism 90 coupled thereto. In an embodiment, a vent 91 is formed in the primary lid for exhausting hot air generated by operation of either the air movement device 86, the motor 88, or the separate cooling mechanism 90 to the exterior of the cooking system 20. However, it should be understood that the air movement device 86 may also be used to circulate air through the enclosure defined between the container 24 and the primary lid 32 when the insert 52 and/or diffuser 40 are not arranged within the container 24.

In an embodiment, the air movement device 86 of the cooking system 20 is a variable speed fan operable at a plurality of rotational speeds. In an embodiment, the operational speed of the air movement device 86 may vary based on the cooking mode selected (see the exemplary, non-limiting parameters and speeds set forth in FIG. 12). For example, the speed of the air movement device 86 during operation in an air fryer mode may be different than the speed of the air movement device during operation in a dehydrator mode. The operational speed of the air movement device 86 may be controlled by the controller 102 in response to one or more inputs 94, including selection of a cooking mode. However, the controller 102 may also be configured to adjust the operational speed of the air movement device 86, or alternatively, the power supplied to the one or more heating elements 82, 84, to control the temperature and/or pressure within the hollow interior 30 of the container 24.

The first and second heating elements 82, 84 are operable independently or in combination to apply one or more predetermined power settings to cook the food products within the container 24 and/or insert 52. In operation, the heating elements 82, 84 are capable of cooking the food products independent of the loading of the food products. In other words, the heating elements 82, 84 are capable of cooking the food products independent of the amount of food products within the container 24.

In some embodiments, the cooking system 20 is operable in more than two cooking modes. For example, the cooking system 20 may be independently operable in any of a slow cooking mode, a pressure cooking mode, an air fryer mode, and a dehydrator mode. Alternatively, or in addition, the at least one input 94 may be used to select operation of the cooking device 20 in a cooking mode that functions as a combination of two or more cooking modes. In such embodiments, the controller 102 may execute a stored sequence where the first heating mechanism 82 is operated during a first portion of the sequence and the second heating mechanism 84 is operated during a second portion of the sequence. For example, in the combination mode, a food item, such as a chicken for example, may be slowly cooked or pressure cooked via operation of the first heating element 82. Then, the second heating element 84 may be operated to air fry the chicken to achieve a crispy exterior layer. However, the embodiments described herein are intended as an example only and any sequence of operation combining both the first and second heating elements is contemplated herein. When operated in a combination of two or more cooking modes, such as a pressure cooker and an air fryer, the food need not be removed from the hollow interior 30, or more specifically the container 24, or even more specifically from the chamber 62 of the insert 52 during such a transition.

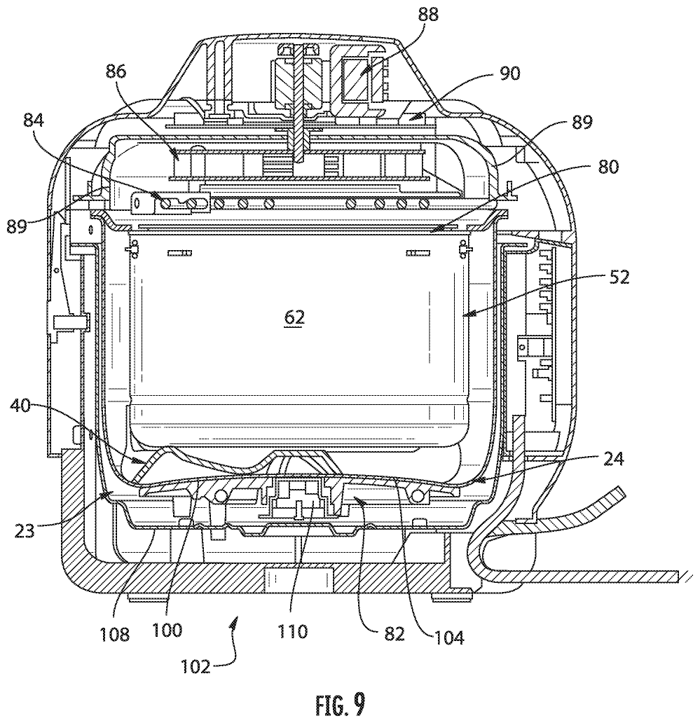

As is alluded to above, the container 24 may be usable in both the first and second cooking modes. In an exemplary embodiment, thermal radiation cooking (second mode), and more specifically air frying is possible in a container (such as container 24) that is deformable for use in a pressure cooking environment (first mode). Containers in which pressure cooking occurs may deform in response to pressure conditions within the pot during cooking. A “domed” or curved shape 100 in a bottom surface 102 (see FIG. 9) of pressure pot such as container 24 may also be employed to handle pressure conditions and the deformity that may result therefrom. Accordingly, since the container 24 may also be used as an air frying chamber, exemplary embodiments of air frying components such as the insert 52 and diffuser 40 may be configured for use in pressure cooking environments. For example, the diffuser 40 may include a curved or sloped bottom surface 104 that conforms to the domed/curved/sloped shape 100 of the bottom surface 102 of the container 24. Indeed, the bottom surface 104 of the diffuser 40 may be curved or sloped to conform to a potentially domed surface of any container (again, such as container 24) used for wet cooking modes such as but not limited to pressure, steam, slow cooking.

In accordance with the above, the insert 52 may be placed in the container 24 with food to be cooked in the first and second modes consecutively. For example, the insert 52 may be placed in the container 24 and food may be placed within the insert for cooking in a first, conductive mode such as pressure or slow cooking. The system 20 may then be switched into the second, thermal radiation mode, and the food still contained in the insert 52 contained in the container 24 can be cooked in accordance with a thermal radiation heating function. In an exemplary embodiment involving pressure cooking and air frying, such a process would involve placing food in the insert 52 and placing the insert in the container 24. The secondary lid 37 would be affixed to the system 20 and pressure cooking would/could occur. Once the pressure cooking is complete, the secondary lid 37 would be removed and replaced with a closed primary lid 32. The food may then be air fried, with all the cooking occurring within the insert 52 disposed within the container 24. Of course, while food would most commonly be cooked first in a conductive/wet mode followed by a thermal radiation/dry mode, the system 20 is certainly capable of cooking food first in a thermal radiation/dry mode followed by a conductive/wet mode.

In some embodiments, it also may be useful to be able to detect presence of the container 24 in the system 20 so operation of the various cooking modes can occur effectively and safely. For example, as shown in FIG. 11 a lower surface 108 of the hollow interior 30 may support a container detection sensor 110 (such as but not limited to a depression or plunger sensor). One or more depression sensors used for container detection and disposed along the vertical extents (i.e. sides) of the liner 23, as well as one or more optical sensors anywhere in the hollow interior 30, are also contemplated.

As mentioned above, and with reference again to FIG. 1A, the system 20 includes a spine 39. In an exemplary embodiment, the spine 39 houses a power/high voltage circuit board under (PCBA in the Figures) the hinge. A UI circuit board is behind the UI (not shown). Referring to FIGS. 20 and 21, the system 20 also includes a first thermal cut off (Bottom or Pressure or PC TCO/TCE) and a second thermal cut off (Upper or AF TCO/TCE). In an exemplary, non-limiting embodiment, the first thermal cut off is proximate the first heating element 82 and is triggered to terminate power thereto in response to a failure of the first heating element. Similarly, the second thermal cut off is proximate the second heating element 84 and is triggered to terminate power thereto in response to a failure of the second heating element 84. It should be noted, however, that the first thermal cut off could get hot enough to trigger a system shut down in response to overheating resulting from the second heating element 84, and the second thermal cut off could get hot enough to trigger a system shut down in response to overheating resulting from the first heating element 82.

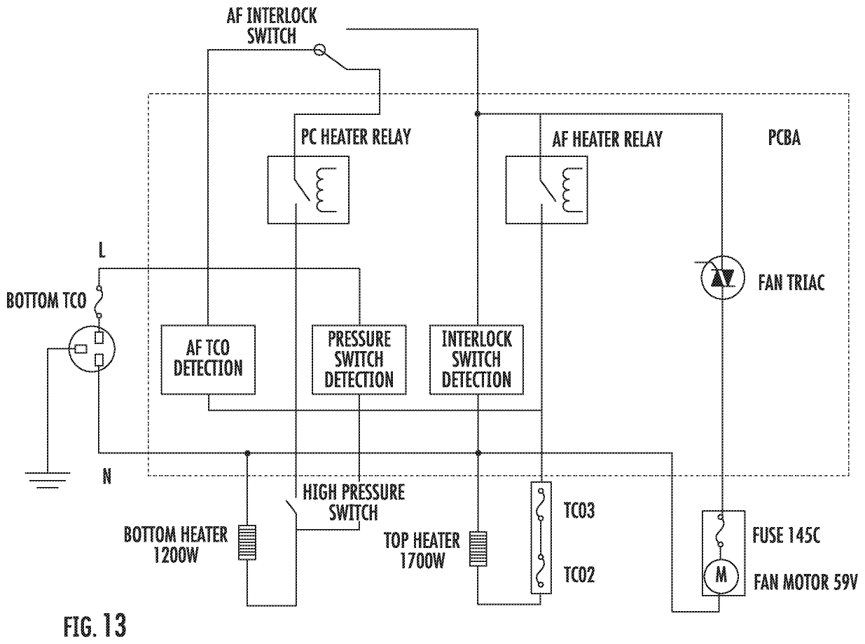

In addition, in an exemplary embodiment, a failure in the first thermal cut off proximate the first heating element 82 will trigger the power circuit board PCBA to terminate power to the system 20 including the first heating element 82, the second heating element 84, and both the power and UI circuit boards. Similarly, a failure in the second thermal cut off proximate the second heating element 84 will trigger the power PCBA to terminate power to the system 20 including the second heating element 84, the first heating element 82, and both the power and UI circuit boards. The system 20 is thereby wired in such a way in that if any thermal cut off is triggered, power is cut to both heating elements 82, 84, rendering the system 20 inoperable. For example, if the first thermal cut off is tripped/triggered during a first mode or wet cooking function, hardware cuts power to both heating elements 82, 84, thereby prohibiting the user from using any cooking function. This circuitry, as shown in FIG. 13, creates a safer system for a user. Alternatively or in addition, the controller 102 may also run software that employs a simple logic check that terminates power to both heating elements 82, 84 if either of the first or second thermal cut offs are tripped/triggered.

Failures such as but not limited to excessive temperature or excessive pressure (as detected by sensors S) may result in the tripping/triggering the first and/or second thermal cut offs discussed above. Software algorithms that correlate temperature to pressure and vice versus may also be employed by the controller 102 to detect dangerous conditions that may trip/trigger the first and/or second thermal cut offs.

With reference now to FIGS. 2, 3A, 3B, and 22A-D, a safety system employing lid detection sensors will now be discussed. A first lid detection sensor 140 is disposed proximate the hinge 38 (and is represented schematically at 140 in FIG. 3A). In an exemplary embodiment, the first sensor 140 is an actuating switch or micro switch that detects whether the primary lid 32 is open or closed. In an exemplary embodiment employing the actuating switch, a power connection to the lid heating element 84 is actually broken when the lid 32 is open. As such the lid heating element 84 can only receive power to actuate thermal radiation cooking modes when the lid 32 is closed. In addition or alternatively, the controller 102 may also run software that employs a simple logic check that terminates power to the heating element 84 when the lid 32 is open.

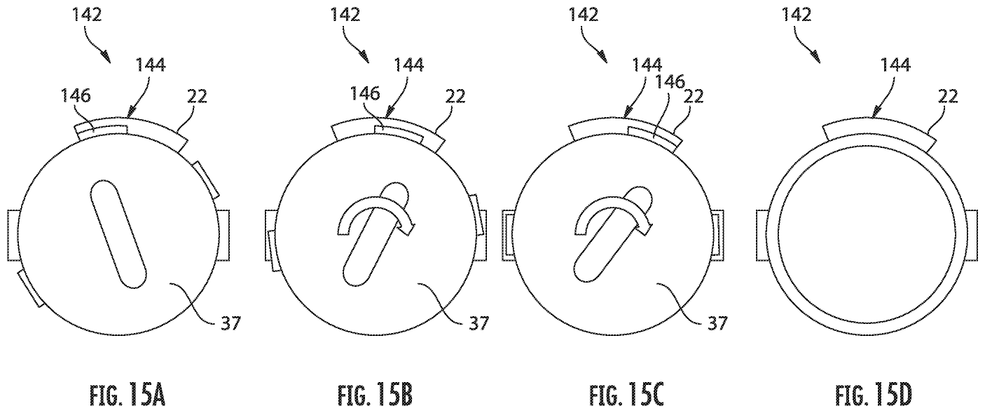

As shown in FIGS. 15A-D, a second lid detection system 142 is shown, and includes a Reed switch/sensor 144 at a relative rear of the housing 22 and a magnet 146 disposed in a corresponding section of the lid 37. As shown in the Figures, a dropped on lid 37 places the magnet 146 within range of the Reed switch 144. When the lid 37 is in this dropped on configuration (15A), the controller 102 may employ a simple logic check that detects the Reed switch's activated condition and terminates power to the whole system 20 or at least the heating elements 82, 84. When the lid 37 is partially engaged on the housing (up to 85% rotation onto a housing bayonet in the exemplary embodiment shown in FIG. 15B), the controller 102 may again employ a simple logic check that detects the Reed switch's activated condition and terminates power to the whole system 20 or at least the heating elements 82, 84. When the lid 37 is fully engaged on the housing 22 (greater than 85% rotated onto a housing bayonet in the exemplary embodiment shown in FIG. 15C), the controller 102 may employ a simple logic check that detects the Reed switch's deactivated condition and allow power to flow normally to the system 20. Similarly, when the lid 37 is not present at all, the controller 102 may employ a simple logic check that detects the Reed switch's deactivated condition and allow power to flow normally to the system 20. However, the controller 102 may also and again employ a simple logic check that detects a closed condition of the first lid 32 and prevent power from flowing to the first heating element 82.

Indeed, when a closed condition of the first lid 32 is detected using the above referenced sensor 140, the controller 102 may deactivate at least the pressure cooking input 94 on the display 92, and in an exemplary embodiment all inputs 94 for the conduction/wet cooking functions including the pressure cooking input 94, slow cooking input 94, steam input 94, and sear/sauté input 94. Similarly, when a closed condition of the second lid 37 (FIG. 15C) is detected using the Reed switch 144, the controller 102 may deactivate all inputs 94 for the thermal radiation cooking functions including the air fry/crisp mode input 94, bake/roast input 94, broil input 94, and dehydrate input 94. In both cases, deactivation of the inputs 94 may include non-function of the inputs 94 and a termination of back lighting to the inputs 94.

The cooking system 20 illustrated and described herein provides an enhanced user experience by combining the functionality of several conventional household products into a single user-friendly device.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Exemplary embodiments of this disclosure are described herein, including the best mode known to the inventors for carrying out the disclosure. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A cooking system for cooking food, the system comprising:
a housing having a hollow interior;
a lid movable relative to said housing;
at least one heating element associated with one of said housing and said lid;
wherein the cooking system is operable in a plurality of modes including a conduction cooking mode and a thermal radiation cooking mode, wherein in said conduction cooking mode the cooking system is operable as a conductive cooker and in said thermal radiation cooking mode the cooking system is operable as a radiative cooker.

2. The cooking system of claim 1, wherein when in said conduction cooking mode the cooking system is operable as at least one of a pressure cooker, steam cooker, slow cooker, searing surface, and sautéing surface, and when in said thermal radiation cooking mode the cooking system is operable as at least one of an air fryer, baking/roasting oven, broiler, toaster, heater, defroster, and dehydrator.

3. The cooking system of claim 1, further including a food container receivable in the hollow interior, wherein food is receivable in said food container in both said conduction cooking mode and said thermal radiation cooking mode.

4. The cooking system of claim 3, wherein said food container includes a container surface, and food is receivable in said food container in contact with said container surface in both said conduction cooking mode and said thermal radiation cooking mode.

5. The cooking system of claim 4, wherein the at least one heating element is a first heating element disposed at or below a lower extent of said container surface, and a second heating element disposed at or above an opening at an upper extent of said food container.

6. (canceled)

7. (canceled)

8. The cooking system of claim 4, wherein said at least one heating element includes a radiative heating element that emits heat energy at infrared wavelengths.

9. The cooking system of claim 4, wherein said at least one heating element includes a radiative heating element that emits heat energy at visible light wavelengths.

10. The cooking system of claim 4, wherein said at least one heating element includes a radiative heating element that emits heat energy at ultraviolet wavelengths.

11. The cooking system of claim 4, wherein said at least one heating element includes a radiative heating element that emits microwaves.

12. The cooking system of claim 4, wherein said at least one heating element includes a radiative heating element that emits radio waves.

13. (canceled)

14. (canceled)

15. (canceled)

16. (canceled)

17. (canceled)

18. (canceled)

19. (canceled)

20. (canceled)

21. The cooking system of claim 1, further comprising a second lid movable relative to said housing to selectively seal said hollow interior.

22. (canceled)

23. (canceled)

24. (canceled)

25. The cooking system of claim 1, wherein said cooking system is transformable between said conduction cooking mode and said thermal radiation cooking mode without removing the food item from said hollow interior.

26. (canceled)

27. (canceled)

28. (canceled)

29. A method for cooking food in a cooking system, the method comprising:
providing a housing having with a hollow interior;
providing a lid movable relative to said housing;
providing at least one heating element associated with one of said housing and said lid;
operating the at least one heating element to cook food in a conduction cooking mode; and
operating the at least one heating element to cook food in a thermal radiation cooking mode.

30. The method of claim 29, wherein said operating in said conduction cooking mode includes operating said at least one heating element to at least one of pressure cook, steam, slow cook, searing, and sauté food, and wherein said operating in said thermal radiation cooking mode includes operating said at least one heating element to at least one of air fry, bake, roast, broil, and dehydrator the food.

31. The method of claim 29, further comprising receiving a food container receivable in said hollow interior, and operating the at least one heating element to cook food in said food container in both said conduction cooking mode and said thermal radiation cooking mode.

32. The method of claim 31, further comprising disposing food in contact with a container surface of said food container, and operating the at least one heating element to cook said food disposed in contact with said container surface in both said conduction cooking mode and said thermal radiation cooking mode.

33. The method of claim 32, wherein the at least one heating element is a first heating element and second heating element, the method further including operating the first heating element to conductively heat said container surface to cook food, and operating the second heating element to thermally radiate an interior of said food container to cook food from an area at or above an opening at an upper extent of said food container.

34. (canceled)

35. (canceled)

36. The method of claim 29, further comprising selectively sealing said hollow interior via a second lid.

37. (canceled)

38. (canceled)

39. (canceled)

40. (canceled)

41. (canceled)

42. (canceled)

43. The method of claim 29, further comprising transforming the system from said conduction cooking mode and said thermal radiation cooking mode without removing a particular food item from said hollow interior.

44. The method of claim 29, wherein said operating said at least one heating element to cook food in said thermal radiation cooking mode includes emitting thermal radiation from said at least one heating element.

45. (canceled)

46. (canceled)

47. (canceled)

48. (canceled)

49. (canceled)

50. (canceled)

51. (canceled)

52. (canceled)

53. (canceled)

54. (canceled)
